(19) United States
(12) Patent Application Publication
(10) Pub. No.: US 2020/0158569 A1
(43) Pub. Date: May 21, 2020

(54) SPECTRAL DETECTOR

(71) Applicant: SHIMADZU CORPORATION, Kyoto (JP)

(72) Inventors: Masato WATANABE, Kyoto (JP); Hiroyuki TOGO, Kyoto (JP)

(21) Appl. No.: 16/604,998

(22) PCT Filed: Apr. 21, 2017
(86) PCT No.: PCT/JP2017/016055

§ 371 Date: Oct. 12, 2019

(51) Int. Cl. G01J 3/02

(52) U.S. Cl. CPC G01J 3/0286; G01J 3/0291

(57) ABSTRACT

A spectral detector includes a light source, a sample cell in which a sample flows therein, an optical sensor, an optical system that guides light from the light source to the sample cell and guides light from the sample cell to the optical sensor, the optical system has a spectroscope for dispersing light and the spectroscope is arranged between the light source and the sample cell or between the sample cell and the optical sensor, and a housing integrally including a lamp house part for housing the light source and an optical system housing part for housing at least the sample cell and the optical system. Since the lamp house part and the optical system housing part are integrated to constitute the housing, heat is easily transmitted from the lamp house part to the optical system housing part, and the time until the entire detector reaches thermal equilibrium is shortened.

### TECHNICAL FIELD

The present invention relates to a detector including a spectroscope in an optical system that guides light from a light source to a sample cell and guides light from the sample cell to an optical sensor, such as a spectrophotometer and a differential refractive index detector (hereinafter, such a detector will be referred to as a “spectral detector”).

### BACKGROUND ART

Spectral detectors, such as an ultraviolet and visible spectrophotometer, a spectrophotofluorometer, a differential refractive index detector, and the like, use a lamp that emits light with heat generation, such as a deuterium lamp, a halogen lamp, and the like, as a light source. In a spectral detector, a light source is stored in a light source storage component called a lamp house. However, an optical system including a spectroscope that guides light to a sample cell or an optical sensor is contained in a storage component (hereinafter referred to as an optical system housing part) that is separate from the lamp house (refer to Patent Document 1).

Light emitted from a light source is introduced into an optical system housing part, and is dispersed by a spectroscope and detected by an optical sensor. A sample cell is disposed on an optical path of light introduced into an optical system housing part, and light that passes through a sample component flowing in the sample cell and fluorescence emitted from the sample component are detected by the optical sensor, so that absorbance and fluorescence intensity of the sample component are measured, based on which sample component is identified and quantified.

### PRIOR ART DOCUMENTS

### Patent Documents

Patent Document 1: Japanese Patent Laid-open Publication No. 2014-048176

### SUMMARY OF THE INVENTION

### Problems to be Solved by the Invention

The light emission intensity of a light source of a spectral detector and the optical characteristics of optical components, such as a spectroscope, constituting an optical system are known to have temperature dependence. Therefore, a certain amount of time is required for a detector signal to stabilize after the detector is started. In particular, when a temperature of a spectroscope, such as a diffraction grating, fluctuates, a relative positional relationship of optical elements mounted on the spectroscope changes, which changes a wavelength dispersion angle and changes spectroscopic performance.

As described above, conventionally, the optical system housing part and the lamp house are thermally separated so that an optical system, such as a spectroscope, is not affected by the heat from the light source. However, in view of a configuration of the detector, the optical system housing part and the lamp house are disposed adjacent to each other. For this reason, the optical system housing part and the lamp house are not completely thermally separated due to the influence of radiant heat from the light source and the like. For this reason, it has been found that heat of the lamp house is slowly transmitted to the optical system housing part, and the lamp house and the entire optical system housing take a long time to reach thermal equilibrium, which causes a time required for a detector signal to be stabilized to become long.

In view of the above, an object of the present invention is to shorten the time until the detector signal is stabilized.

### Solutions to the Problems

In a conventional spectral detector, it is common technical knowledge that a light source and an optical system are thermally separated from the viewpoint of suppressing the influence of heat from the light source on the optical system. On the other hand, the present invention is based on the idea that the time until the entire detector reaches thermal equilibrium is shortened by facilitating heat to be transmitted from the light source to the optical system.

That is, the spectral detector according to the present invention includes a light source, a sample cell in which a sample flows therein, an optical sensor, an optical system that guides light from the light source to the sample cell and guides light from the sample cell to the optical sensor, the optical system has a spectroscope for dispersing light and the spectroscope is arranged between the light source and the sample cell or between the sample cell and the optical sensor, and a housing integrally including a lamp house part for housing the light source and an optical system housing part for housing at least the sample cell and the optical system. Since the lamp house part and the optical system housing part are integrated to constitute the housing, heat is easily transmitted from the lamp house part to the optical system housing part, and the time until the entire detector reaches thermal equilibrium is shortened.

The housing is preferably made from a heat conductive material. In this manner, the heat generated by the light source is transmitted to the entire housing with high efficiency, and the time until the entire detector reaches thermal equilibrium is shortened.

Further, a cooling mechanism for cooling the lamp house part in the housing is preferably included. If the lamp house part that directly receives heat from the light source is actively cooled, the temperature difference between the lamp house part and the optical system housing part becomes small, and the time until the entire detector reaches thermal equilibrium is further shortened.

In the above case, various configurations of the cooling mechanism for cooling the lamp house part in the housing are conceivable. For example, it is conceivable to provide a cooling fin in the lamp house part and to blow cooling air from a fan to the fin. However, if the cooling air is blown directly to the lamp house, the lamp house part may vibrate, and the light source may vibrate accordingly, which may cause noise in the detector signal. Further, if the cooling fin is provided in the lamp house part, there is a problem that the structure of the housing becomes complicated and the manufacturing cost of the housing increases.

In view of the above, the cooling mechanism may include a heat pipe that absorbs heat of the lamp house part in the housing and transports the heat to a position away from the housing. In this manner, the cooling air is not directly blown to the lamp house part in the housing, and generation of noise by vibration of the light source can be prevented. Further, since it is not necessary to provide the cooling fin in the housing, an increase in the manufacturing cost of the housing can be suppressed.

Here, the heat pipe is one in which a working liquid is sealed inside a metal pipe that is vacuum evacuated. The heat pipe can perform heat transport highly efficiently by latent heat transfer, in which, when the temperature difference occurs between one end and the other end of the heat pipe, the working liquid evaporates on the higher temperature side and becomes vapor, and the vapor condenses on the lower temperature side to become liquid.

Further, the spectral detector of the present invention may further include a heat transport mechanism that is attached to the housing and is for transporting heat of the lamp house part in the housing to the optical system housing part. In this manner, heat transport is performed highly efficiently from the lamp house part to the optical system housing part, and the time required for thermalization of the entire detector is further shortened.

An example of the heat transfer mechanism is a heat pipe.

### Effects of the Invention

In the spectral detector according to the present invention, the lamp house part and the optical system housing part are integrated to constitute the housing. Accordingly, the time until the entire detector reaches thermal equilibrium is shortened, which shortens the time required for the detector signal to be stabilized.

Further, in a case where the lamp house part and the optical system housing part are configured as separate bodies and thermally separated as in the conventional technique, the light source is easily affected by room temperature fluctuation because the heat capacity of the lamp house part is small. On the other hand, in the present invention, the lamp house part and the optical system housing part are integrated to constitute one housing, so that the heat capacity of the lamp house part and the optical system housing part becomes large, and an influence of room temperature fluctuation on the light source and the optical system becomes small.

In order to further suppress the influence of room temperature fluctuation, a temperature control mechanism, such as a heater or a sensor, may be provided. However, if the lamp house part and the optical system housing part are thermally separated, a heater, a sensor, and the like need to be provided in each of the parts in order to suppress the influence of room temperature fluctuation on each of the parts. On the other hand, in a case where the lamp house part and the optical system housing part are integrated, the temperature control mechanism does not always need to be provided in each of the lamp house part and the optical system housing part, and temperature control of the lamp house part and the optical system housing part can be performed with one temperature control mechanism. Further, since the lamp house part and the optical system housing part constitute one housing, the number of components constituting the detector is reduced, and cost reduction can be achieved. Furthermore, as two sets of the temperature control mechanisms are conventionally required, one set of the temperature control mechanism is used. In such a case, the number of components constituting the detector is further reduced, and further cost reduction can be achieved.

### BRIEF DESCRIPTION OF THE DRAWINGS

FIG. 1 is a schematic configuration plan view showing one embodiment of a spectral detector (spectrophotometer).

FIG. 2 is a perspective view showing a housing of the embodiment.

FIG. 3 is a graph showing a verification result of the influence on a spectroscope temperature due to a room temperature fluctuation in a conventional structure and a structure of the embodiment.

FIG. 4A is a graph showing a temporal change in a lamp house temperature and a spectroscope temperature in a conventional structure.

FIG. 4B is a graph showing a temporal change in a lamp house temperature and a spectroscope temperature in the embodiment.

FIG. 5 is a perspective view showing an embodiment in which a cooling mechanism is mounted on the housing.

FIG. 6 is a schematic configuration plan view showing another embodiment of the spectral detector (spectrophotometer).

### EMBODIMENTS OF THE INVENTION

Hereinafter, a spectrophotometer as an embodiment of the spectral detector of the present invention will be described with reference to the drawings.

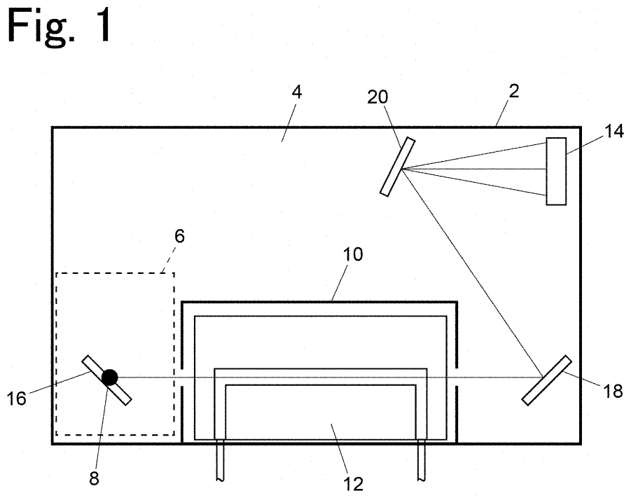

As shown in FIG. 1, the spectrophotometer of the present embodiment includes a light source 8, a sample cell 12, an optical sensor 14, mirrors 16 and 18, and a diffraction grating 20 housed in a housing 2 made from a heat conductive material, such as aluminum.

The housing 2 includes an optical system housing part 4 and a lamp house part 6. The lamp house part 6 is provided at a position above the optical system housing part 4, and the light source 8 is housed in the lamp house part 6. The light source 8 is a deuterium lamp or a halogen lamp. The light source 8 is disposed so as to emit light in a downward direction (a direction perpendicular to the surface of the drawing).

A sample cell installation unit 10 is provided in the optical system housing part 4 of the housing 2, and the sample cell 12 is installed in the sample cell installation unit 10. The mirror 16 is provided at a position directly below the lamp house part 6 in the optical system housing part 4 so as to reflect the light from the light source 8 and guide the light to the sample cell 12. The mirror 18 is arranged on an optical path of light that passes through the sample cell 12, and the diffraction grating 20 as a spectroscope is disposed on an optical path of light reflected by the mirror 18. Light incident on the diffraction grating 20 is dispersed by wavelength regions. The optical sensor 14 including a photodiode array is disposed at a position for receiving light in each wavelength region that is dispersed by the diffraction grating 20. The mirror 16 forms an optical system for guiding light from the light source 8 to the sample cell 12, and the mirror 18 and the diffraction grating 20 form an optical system for guiding light from the sample cell 12 to the optical sensor 14.

Light emitted from the light source 8 is reflected by the mirror 16 and applied to the sample cell 12. Light that passes through the sample cell 12 is reflected by the mirror and guided to the diffraction grating 20, and the intensity of the light in each wavelength region dispersed by the diffraction grating 20 is detected by the optical sensor 14. By detecting the intensity of light in each wavelength range obtained by the optical sensor 14, an absorption wavelength and absorbance of a sample component flowing through the sample cell 12 are measured, and the sample component is identified and quantified.

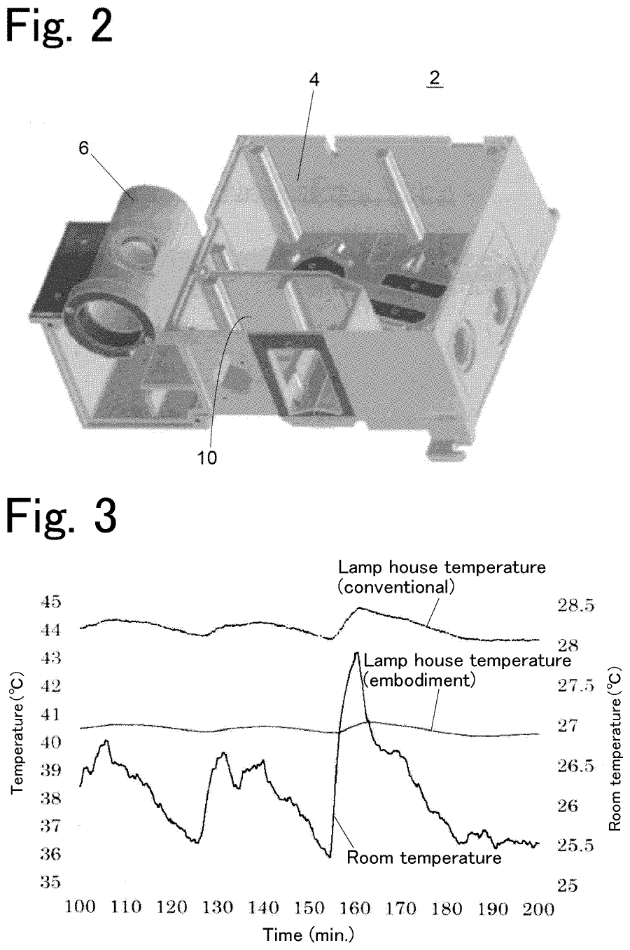

As shown in FIG. 2, in the present embodiment, the optical system housing part 4 and the lamp house part 6 are integrated to constitute one housing 2. In the conventional structure, the lamp house exists as a single unit. However, the lamp house itself, which has a small heat capacity, is easily affected by room temperature fluctuation. On the other hand, if the optical system housing 4 and the lamp house part 6 are integrated into one housing 2 as in the present embodiment, the heat capacity of the housing 2 as a whole becomes large. Accordingly, the lamp house part 6 is hardly affected by a room temperature fluctuation as compared with the conventional structure in which the optical system housing part and the lamp house are thermally separated.

FIG. 3 shows a verification result of the influence on a temperature of the lamp house part 6 due to room temperature fluctuation in the conventional structure and a structure of the present embodiment. As can be seen from this graph, in a case of the conventional structure, that is, in a case where the optical system housing part and the lamp house are thermally separated, a temperature of the lamp house fluctuates significantly under the influence of room temperature fluctuation. However, in the structure of the embodiment in which the optical system housing part 4 and the lamp house part 6 are integrated, temperature fluctuation of the lamp house part 6 is smaller than that of the conventional structure. This verification result shows that if the optical system housing part 4 and the lamp house part 6 are integrated, the influence of room temperature fluctuation on the lamp house part 6 is reduced.

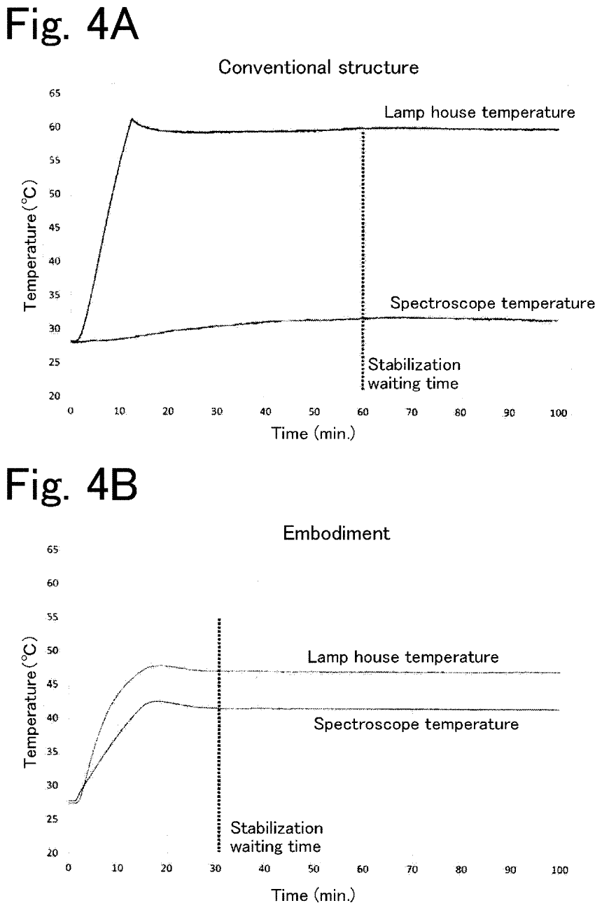

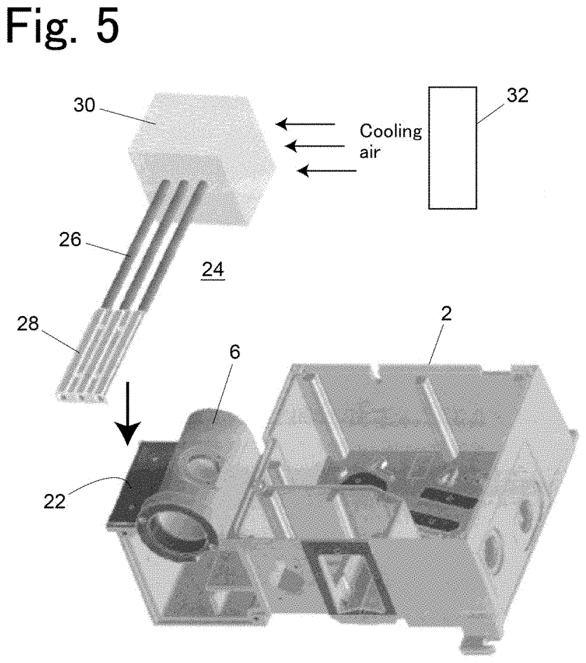

Further, the light source 8 housed in the lamp house part 6 emits light with heat. The heat generated by the light source 8 is transmitted to the optical system housing part 4 through the lamp house part 6 with high efficiency, and thermalization of the entire housing 2 is promptly established. A verification result relating to thermalization is shown in FIGS. 4A and 4B.

FIGS. 4A and 4B show a measured temporal change in a lamp house temperature and a spectroscope temperature after the light source is turned on. As shown in Fig.4A, in the conventional structure where the optical system housing part and the lamp house are thermally separated, the difference between a lamp house temperature and a spectroscope (optical system) temperature is large, and the time of about 60 minutes is required until both temperatures are stabilized after the light source is turned on. On the other hand, in the structure of the embodiment in which the optical system housing part 4 and the lamp house part 6 are integrated, as shown in FIG. 4B, the difference between a lamp house temperature and a spectroscope (optical system) temperature is small. Furthermore, the time required to stabilize both temperatures after the light source is turned on is shortened to 30 minutes.

This verification result shows that the time required for thermalization of the entire detector is shortened by integrating the optical system housing part 4 and the lamp house part 6 to constitute one housing 2. In this manner, the time required for the detector signal to become stable (stabilization waiting time) is shortened in the structure of the present embodiment as compared with the conventional structure.

As can be seen from the verification result of FIG. 4B, when the light source 8 is turned on, the temperature of the lamp house part 6 becomes higher than the temperature of the optical system housing part 4. However, if the temperature difference between the optical system housing part 4 and the lamp house part 6 becomes smaller, the time required for the thermalization of the entire detector can be further shortened. As a method of further reducing the temperature difference between the optical system housing part 4 and the lamp house part 6, it is conceivable to provide a cooling mechanism for cooling the lamp house part 6.

FIG. 5 shows an example of the cooling mechanism for cooling the lamp house part 6 of the housing 2. A cooling mechanism 24 in this example uses a heat pipe 26. A heat transfer plate 28 is attached to one end side of the heat pipe 26, and a radiation fin 30 is attached to the other end side. The heat transfer plate 28 is attached so as to be in close contact with a flat surface portion 22 provided in the vicinity of the lamp house part 6 of the housing 2, and a fan 32 blows cooling air to the radiation fin 30 attached to the other end side of the heat pipe 26. In this manner, the heat of the lamp house part 6 is efficiently transported to the other end side of the heat pipe 26. Note that pure water is exemplified as a working fluid sealed in the heat pipe 26.

Various configurations of the cooling mechanism for cooling the lamp house part 6 are conceivable. However, by using the heat pipe 26 as shown in FIG. 5, cooling air no longer needs to be directly blown to the lamp house part 6, and the occurrence of noise due to vibration of the lamp house part 6 can be prevented. Note that, although not shown in FIG. 5, the radiation fin 30 attached to the other end side of the heat pipe 26 is preferably disposed in space that is thermally isolated from space in which the housing 2 is disposed.

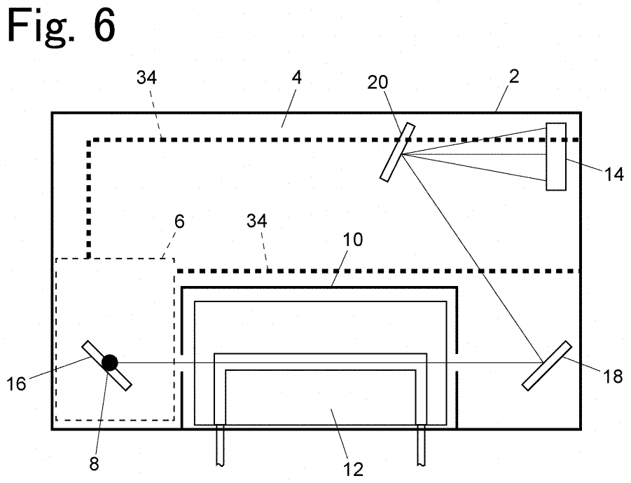

Further, in order to expedite the thermalization of the entire detector, as shown in FIG. 6, a heat pipe 34 (heat transport mechanism) may be used to actively transport the heat of the lamp house part 6 to a position away from the lamp house part 6 in the optical system housing part 4.

The above embodiment describes a spectrophotometer of a post-spectral system as the spectral detector. However, the spectral detector of the present invention is not limited to this, and the present invention can be applied to any detector, as long as the detector includes a spectroscope in an optical system, such as a spectrophotometer of a pre-spectral system or a differential refractive index detector.

### DESCRIPTION OF REFERENCE SIGNS

2: Housing

4: Optical system housing part

6: Lamp house part

8: Light source

10: Sample cell installation unit

12: Sample cell

14: Optical sensor

16, 18: Mirror

20: Diffraction grating (spectroscope)

22: Flat surface portion

24: Cooling mechanism

26, 34: Heat pipe

28: Heat transfer plate

30: Radiation fin

32: Fan

Amendments in the claims:

1. A spectral detector comprising:
a light source;
a sample cell in which a sample flows therein;
an optical sensor;
an optical system that guides light from the light source to the sample cell and guides light from the sample cell to the optical sensor, the optical system has a spectroscope for dispersing light and the spectroscope is arranged between the light source and the sample cell or between the sample cell and the optical sensor; and
a housing including a lamp house part for housing the light source and an optical system housing part for housing at least the sample cell and the optical system, the lamp house part and the optical system housing part are integrated with each other.

2. The spectral detector according to claim 1, wherein the housing is made from a heat conductive material.

3. The spectral detector according to claim 1, further comprising a cooling mechanism for cooling the lamp house part in the housing.

4. The spectral detector according to claim 3, wherein the cooling mechanism includes a heat pipe that absorbs heat of the lamp house part in the housing and transports the heat to a position away from the housing.

5. The spectral detector according to claim 1, further comprising a heat transport mechanism that is attached to the housing and is for transporting heat of the lamp house part in the housing to the optical system housing part.

6. The spectral detector according to claim 5, wherein the heat transfer mechanism is a heat pipe.
